(19) United States
(12) Patent Application Publication
(10) Pub. No.: US 2010/0064952 A1
(43) Pub. Date: Mar. 18, 2010

(54) Method and Means for Using Commom Dusts as Fuel for and Engine

(75) Inventor: Lawrence George BROWN, Danville, CA (US)

Correspondence Address: Lawrence G. Brown, 9000 Crow Canyon Rd, S 398, Danville, CA, 94506, US

(73) Assignee: Lawrence George Brown, Danville, CA (US)

(21) Appl. No.: 12/551,576

(22) Filed: Sep. 1, 2009

Related U.S. Application Data
(60) Provisional application No. 61/093,963, filed on Sep. 3, 2008.

(51) Int. Cl. F23D 1/00; F03B 3/00

(52) U.S. Cl. 110/263; 415/80

(57) ABSTRACT

A combustion device, relying on the Newtonian principle of equal and opposite reaction to create rotational output, using dust/air mixtures for creating explosions within the burn chambers, creating distilled water and sodium carbonate as byproducts, and using washable rotating screens and liquid scrubbers to purify exhaust, and centrifuges in turn to purify and recirculate the scrubbing means

### PRIOR REFERENCE

My prior Provisional Patent Applications No. 61/134,803, filed on Jul. 15, 2008, and No. 61/093,963, filed on Sep. 3, 2008, underlie the current application, and is hereby made a part thereof.

### BACKGROUND

1. Field

Field of this invention is basic useable energy creation—conversion of a fuel, or group of fuels, into further exploitable forms of energy.

2. Prior Art

Attempts to use solid combustible fuels in powder form were made; most were based on using coal dust; virtually all were attempts to incorporate the powdered, or otherwise transformed fuels into the currently used internal combustion engines, or some version thereof. Up to the present moment we have not been able to find any prior art which—in my obviously amateur opinion—would be relevant enough to bring it to the examiner's attention. I hope that in the end the USPTO—even after examining the yet to be submitted Professional Responsibility Statement—will agree.

### GENERAL BACKGROUND

The enormous power of unexpected dust explosions is well documented; while many of such blasts were in mining, and coal dust was the most recognized source of such disasters, a long list of other dusts—created by both industrial processes as well as just Nature—has also been at work. Whole plants, buildings, have been destroyed. Just last month three more people lost their lives when a tank partially filled with fiber exploded with a force of a bomb. The government lists the following industries as producing waste byproducts suitable as fuel in our engine by themselves, or as fuel mixture ingredients: agriculture, chemicals, food, grain, fertilizer, tobacco, plastics, forest, paper, rubber, furniture, textiles, pesticides, pharmaceuticals, tire and rubber, dyes, coal, metal processing, recycling, mining. Except for coal, most sources of dust produce far less, and far less detrimental, pollutants than presently used fuels used to provide us with energy.

### ADVANTAGES

Petroleum use would slide over time to a minor role. Cost of fuel (almost ANY waste will do) will be only that of collection and reduction to particles below 500 microns. Present pollution problems will be almost gone.

Engines would available to most isolated areas. Mobile (first ships, locomotives, trucks, busses, followed by automobile) propulsion would be just a matter of time. The system would have relatively few moving parts, no lubricants are need or coburned in the Explosion Vessels. There is virtually no limit of how long the output shaft should be, if units such as envisioned in FIG. 1 are placed at intervals along the shaft. Localized electrification w/o transmission lines, and unprecedented irrigation capabilities would become available wherever such an engine would be placed, with resulting benefits to humanity.

### SUMMARY OF THE INVENTION

All the five conditions necessary for a natural dust explosion (the ‘pentagon’) are created in a vessel of at least the minimum size needed for such explosion to occur, with 10 liters being a good start:

The vessel must have the conditions of an enclosed space;

There must be provided the proper ratio of oxidizing matter to the dust intended as fuel;

The dust must not exceed 500 microns in particle size, and if dual chamber ignition is to be applied, less than 40 microns in the ignition zone;

Sufficient dispersion means properly oriented need to be applied;

Ignition, chemical and or electric, must be provided at specific point of fuel/oxidizer means interaction;

Upon the explosion, the Newtonian principle of “equal and opposite reaction” is used to transfer to, and store in, a rotating mass, the effect of the explosion. Explosions are sequenced in a timing permitting the harvesting of the energy so acquired—maintaining an operational rotational speed without an undesirable decay of momentum.

### DRAWINGS

FIG. 1 pictures the motive part of the initial Engine only

FIG. 2 a side view of same, with exhaust and sound capturing enclosure

FIG. 3 a more compact engine

FIG. 4 side view of engine in FIG. 3, with pollutants scrubbing and distilled water making unit Fi

### REFERENCE NUMBERS

40 and 80: explosion containing vessel (burn chamber)
42, 81 beams carrying said vessels
42, 43, 46 conduits delivering fuel, dispersion means, and ignition
48, 80a manifolds conducting flow into the explosion vessels
50, 82 output shaft
51, 51a, 52, 54 delivery from manifold controls
53 flywheel
54 chamber doors tripp lever
56 doors
58 over the center springs operating chamber doors
60, 83 enclosure
62 fans
64 rotating screen
65 screen scrubber bath
67 exhaust fans
69 catalytic converter
71 centrifuges
73 PM filter
85 hottest gas conduit
86 distiller and collection
90 liquid scrubbers
100 centrifuges

### INITIALLY PREFERRED EMBODIMENT

### Stationary Power Generating Plant

FIG. 1 displays only the Energy Creating Parts of the Engine:

Explosion Containing Vessels 40a, 40b, 40c, and 40d, are fixedly mounted on ends of tubular Beams 42a, and 42b. Air conduits 43, Fuel conduits 44, and Ignition conduits 46 are connected to each vessel 40 thru thereto attached manifolds 48a, 48b, 48c, and 48d. Said conduits bring fuel, air, and ignition assistance to the interior of vessels 40 from external devices, traveling thru the hollowed centers of beams 42a and 42b, as well as the Output Shaft 50. Flywheel 52 is added for both stability and increased inertial energy storage capability. Pls NOTE: only ONE vessel 40 mounted on end of a beam 42, (with counterbalancing weight provided on the other end of beam 42) is needed to turn Output Shaft 50, thus providing a functioning power generating device. Addition of the other 3 vessels 40 is an arbitrary choice, it could have been only a second vessel, or any number more.

Initial Physical Requirements of Fuel and Vessel:

FUEL: Virtually any vegetation remnant is preferred; ground down to 500 microns or below, stalks of nearly any vegetation, properly dried, will work. The explosiveness of say, wheat straw, is not a high as starch containing corn leftovers, or sugar cane. Experience and availability will be the guide for any local engine users.

Hemp, Lycopodium, Pectin, and Ranwolf Root—if they could be locally cultivated—would be of benefit.

While no particle for use as fuel should be larger in any dimension than 500 mu (micrometers), the preferred size range of particles in the fuel mix should initially be 125 to 325 muM, with the probable best starting target of 200 muM (with 40 mu or less best for ignition zones); The probable best starting internal volume of the combustion chambers should be such that no less than 10 liters (0.01 m3) of oxidant (free air) is present when fuel is delivered for dispersion therein. In the initial tests the Air Fuel Ratio (APR) should be 200 gm/m3-1200 gm of fuel (in particle form) per m3 (meter cube) of air. 1 Clearly, not much knowledge now exists about this area. Swings away from my initial anticipated values shown above, as well as the initial mechanisms, are to be expected—but the use of such particles as a fuel will hopefully come into practice.

The Engine will be started by electric, or preferably pneumatic energy stored prior to its last shutdown. As the vessel 40 leaves 40a position with the engine rotating counterclockwise, interior of the vessel 40 is flushed clean with air jets in the manifold 48; vessel 40 now is filled with normal air—our oxidizing agent in dust explosions, and the jets keep the air inside 40 swirling; (No 1 of the 5 conditions is achieved).

As the vessel moves thru the 40b position, stationary pins 54 swing doors 56a and 56b closed.

Springs 58a and 58b get pulled over the center, keeping the doors shut; volume in vessel 40 is contained; perfect sealing is not required, (No. 2 of five requirements for a dust explosion is achieved)

Fuel injection activator 51, via fuel variability finger 51a (so called because the finger is adjustable to alter the degree of movement it forces in the fuel injector 52 in manifold 48, and therefore controls the amount of fuel delivered to the inside of vessel 40 as it passes) presses 52 in, dumping fuel into the swirling air inside 40. (No. 3 of 5 requirements for a dust explosion is now there)

As 40 arrives at position 40c, the swirling air jets have already reasonably dispersed the fuel delivered throughout the contained air volume inside 40 (the No. 4 of 5 conditions for a dust explosion is here).

Now any provocation to ignition (the No. 5 requirement), will give us the explosion we seek to generate: exposure to an open flame, a blow torch starter, a glow plug, a magneto spark, or any of the many other ways to ignite which will occur to those skilled in the art, and the explosion throws open the doors of 40; as it expels the products of combustion it gives an “equal and opposite” kick to the mass of this engine, transferring the benefit of this explosion into increased rotational energy available to be taken from the output shaft 50. NOTE: timing for ignition in this device is lax in this device. Dust Explosion any place around the wheel still works—order is reestablished as wheel rotates.

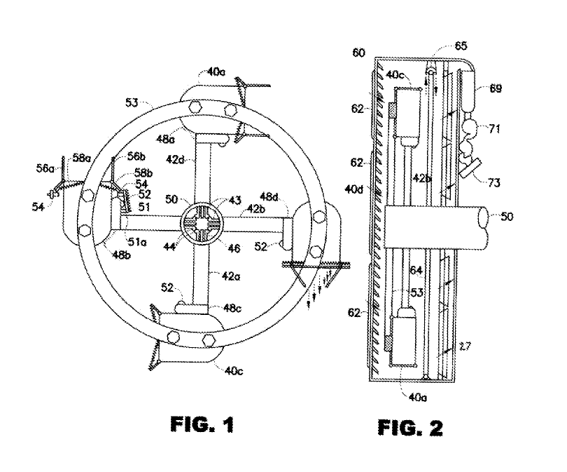

FIG. 2 displays one way the Dust Engine could be packaged, for noise suppression, heat dissipation, and exhaust treatments;

In Operation:

Sound Proofing Enclosure 60 has in its back wall a series of “one way” fans 62, blowing a wind across the engine and thru the double screen 64, which rotates continuously up and down thru a screen scrubber bath 65 at its lowest point. Additional optional front fans 67 are shown in front of rotating screen 64, amplifying the action of the rear fans 62 and blowing out of the enclosure 60 all that is in it thru catalytic converter 69, a series of centrifuges 71, and final check for remaining particle matter filter 73.

CLEARLY, other mechanisms and combinations (such a turbines, jets, cylinder/piston combinations etc) can be applied in place or in addition to this FIRST approach of crating all the 5 conditions for DUST EXPLOSION and then harnessing same into useable energy. We need to conduct convincing tests first showing that complicating this admittedly primitive approach would yield gains sufficient to pay the various prices that will come with complications. If so, we'd hope to proceed in whatever will be developed as a next step forward.

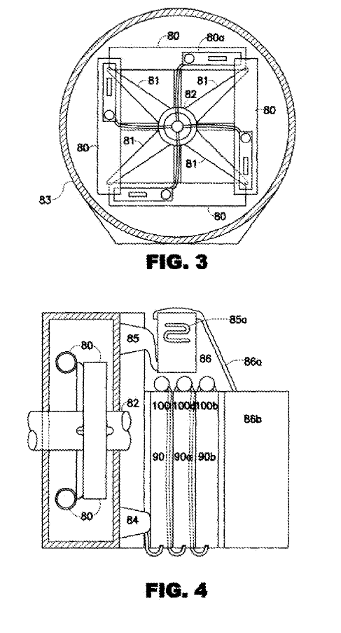

FIG. 3 depicts a more compact version of the same in principle design engine; output shaft 82 carries on arms 81 the 4 combustion chambers 80; each such chamber has affixed thereto a manifold like 80a; each chamber is identical in principle to those described in FIG. 1. The engine rotates in the enclosure 83.

FIG. 4 shows the processing of the products of combustion which result from the explosions created in chambers 80: the hottest portion on top of enclosure 83 is directed thru conduit 85 to a distiller 86, and brings to boil a quantity of water placed therein—which is replenished automatically as it boils off. The so generated steam exits thru air cooled coils 85a, in which it begins to condense into distilled water, which continues thru conduit 86a to be collected in storage vessel 86b.

The rest of the gases in enclosure 83 are driven out thru conduit 84, and forced into the bottom of 90, which is filled with just water or any other suitable liquid intended to scrub, remove from the passing gasses impurities such as particularly the Particle Matter which exited the explosions as ashes, and or partially burned remnants of the fuel powders, as well as other possible pollutants arising from the nature of the powder mix used to power the engine. As the gases reach the top of column 90, they enter a centrifugal device which can force the gases into another scrubbing trip thru column 90a, etc if needed. The centrifuges remove sludge as well.

Additionally, using known methods in the scrubbing process, part of the exiting CO2 can be precipitated into Sodium Carbonate, a saleable product, as well befitting the environment.

1. At least one vessel of any shape to serve as the burning chamber, mounted on a connecting means at some distance from the supporting center of rotation, of not less than 5 liters in size, carrying oxidizing means containing within it a mixture of ignitable dusts maintained in dispersion by movement of said oxidizing means
Said vessel further possessing closable apertures to provide for confinement of said mixture in said vessel
Still further providing accessibility of said dispersed mixture within said confined vessel to ignition means of any kind at times externally dictated.

2. A device of claim 1 where the majority of said ignitable dusts consist of particles ranging in size from 20 to 500 microns.

3. A device of claim 1 where the ratio of mass of the combined dust particles to the mass of the oxidizing means ranges from 50 gm/meter cu to 500 gm/m cu.

4. A device of claim 1 where the burning chamber vessel has a manifold for delivery as well as control of said oxidizer, fuel, ignition means.

5. A device of claim 1 where the fuel delivery system fluidizes the dusts within it.

6. A device of claim 1 where the oxidizing means is compressed.

7. Combustion device where the hottest combustion exhaust gases are used to distill water.

8. Combustion device where the exhaust gasses are screened by rotating screens being being constantly scrubbed themselves.

9. Combustion device where the exhaust gases are passed thru liquid scrubbers to be purified.

10. Device of claim 9 where the scrubbing liquids are passed thru centrifuges to remove the sludge.

11. Device of claim 1 where the exhaust is use to precipitate Sodium Carbonate.
